(19) United States
(12) Patent Application Publication
(10) Pub. No.: US 2002/0120833 A1
(43) Pub. Date: Aug. 29, 2002

(54) Method for automatic obtaining the ID number of items of a volume control program

(75) Inventors: Tong S. Chen, Taipei (TW); Kuang-Shin Lin, Taipei (TW)

Correspondence Address: BAKER & BOTTS, 30 ROCKEFELLER PLAZA, NEW YORK, NY, 10112

(73) Assignee: INVENTEC CORPORATION

(21) Appl. No.: 09/783,766

(22) Filed: Feb. 15, 2001

(51) Int. Cl. G06F 15/177; G06F 9/24; G06F 9/00

(52) U.S. Cl. 713/1

(57) ABSTRACT

A method for automatic obtaining the ID number of items of a volume control program is disclosed. The method comprises three main steps: turning on a volume control program, detecting items and calculating an ID number of each item. The first step is turning on a volume control program, for example, turning on the volume control program from a start catalog of Microsoft Windows. The second step is detecting items, which is searching a desired item whether present in a control plane of the volume control program. If the item is present in the control plane of the volume control program, an ID number of the item can be obtained. The third step is calculating the ID number of the item, which is calculating the ID number of each item such as volume, left-right sound track and muteness by using the obtained ID number of the item.

### FIELD OF THE INVENTION

The present invention relates to a method for automatic obtaining the ID number of items of a volume control program, and particularly to obtain the ID number of items of a volume control program. The present invention is applied to a computer of various hardware and window environments and to verify that all of the computers have a single ID number.

### BACKGROUND OF THE INVENTION

The software and operation stages of a computer, such as window software produced by Microsoft Corp., have many default standard control items. Typically, a control item set manual by an operator or a detector to achieve a default state.

However, before adjusting a control item of sound of a computer such as volume control, left-right sound track and muteness. When an operator takes a detection program, the operator adjusts the control item only in a case of obtaining a window ID of related items of a volume control program. However, a window ID of an item is obtained via its ID number. In present technologies, though a window ID number of an item can be manual obtained, but there are many defects still exist, for example, because a window ID number of an item is not a fixed value for various designs of a volume control programs, thus the design must be manually changed to an identifiable design for detecting. If with many computers needed to be detected, spending a long time is unavoidable for adjusting a design. In addition, when a method for manually adjusting a design is adopted and the adjusted design is processed not based on a standard step, then a detection error may occurs. Furthermore, the performance will be very bad for manually obtaining an ID number. Because each person has a different conventional method and with a different operation habit, so that the operation process can not be standardized. Further, the results in a high rate of error by a manual intervention. For example, when detecting different computers with different language forms, it is possible to choose an error or miss a choice to result in an outcome of a detection error. Therefore, a method for automatic obtaining the ID number of items of a volume control program is necessary for solving the disadvantages occurred in the conventional technology.

### SUMMARY OF THE INVENTION

The present invention provides a method for automatic obtaining the ID number of items of a volume control program, which can effectively solve the above disadvantages, occurred in the conventional technology.

The present invention provides a method for automatic obtaining the ID number of items of a volume control program, which can avoid the complication and inaccuracy occurred by a manual operation.

The present invention provides a method for automatic obtaining the ID number of items of a volume control program, which can standardize the detection process.

The present invention provides a method for automatic obtaining the ID number of items of a volume control program, which can enhance the accuracy and performance of the detection step of the adjustment process.

The present invention provides a method for automatic obtaining the ID number of items of a volume control program, which has a tidy compatibility and can broad apply to various computers and hardware without limiting at a type of the computer and a design of hardware.

According to the above objects, the present invention provides a method for automatic obtaining the ID number of items of a volume control program at least comprises the steps of: turning on a volume control program, detecting an item and calculating an ID number of another item.

The step of turning on the volume control program further comprises a step of determining a denotation corresponded to the volume control program whether present in a tragbar. If the denotation is present in the tragbar, then turning on the volume control program to display a volume control plane. If the denotation is not present in the tragbar, then searching a related path corresponded to the volume control program whether present in a START function program. If the related path corresponded to the volume control program is present in the START function program, then turning on the volume control program to display a volume control plane. If the related path corresponded to the volume control program is not present in the tragbar, then stopping the process. If the related path corresponded to the volume control program is not present in the START function program, then stopping the process.

Furthermore, the step of detecting the item further comprises the steps of; reading a described message of the item and determining whether contents of the item of the volume control plane is the same as the described message of the item. If the contents are the same as the described message of the item, then an ID number of the item can be obtained and to calculate the ID number of the another item. If the contents are not the same as the described message of the item, then stopping the process.

### BRIEF DESCRIPTIONS OF THE DRAWINGS

FIG. 1 shows a flowchart of automatic obtaining the ID number of items of a volume control program according to the present invention;

FIG. 2 shows a flowchart of a method for turning on a volume control program according to the present invention;

FIG. 3 shows a flowchart of detecting items according to the present invention; and

FIG. 4 shows a flowchart of calculating the ID number of items according to the present invention.

### DETAILED DESCRIPTIONS OF THE INVENTION

The present invention discloses a method for automatic obtaining the ID number of items of a volume control program. The method comprises three main steps: turning on a volume control program, detecting items and calculating an ID number of each item. The first step is turning on a volume control program, for example, turning on the volume control program from a start catalog of Microsoft Windows. The second step is detecting items, which is searching a desired item, such as, MIDI, whether present in a control plane of the volume control program. If the item is present in the control plane of the volume control program, an ID number of the item can be obtained. The third step is calculating the ID number of the item, which is calculating the ID number of each item, such as, volume, left-right sound track and muteness by using the obtained ID number of the item. Additionally, the method for automatic obtaining the ID number of items of a volume control program of the invention is not only limited in a case of automatic obtaining the ID number of items of the volume control program. It is must be noticed that the invention also applies to automatic obtain the ID number of items of other control programs.

A method for solving the conventional problems and a preferred embodiment of the invention will be described in detail as below.

When a user or an operator need to automatic detect the volume control item such as MIDI volume, left-right sound track and muteness, which can be performed by using the disclosed method of the invention. It is must be noticed that the application of the invention is not limited in above three volume control items, the invention applies to all the volume control items.

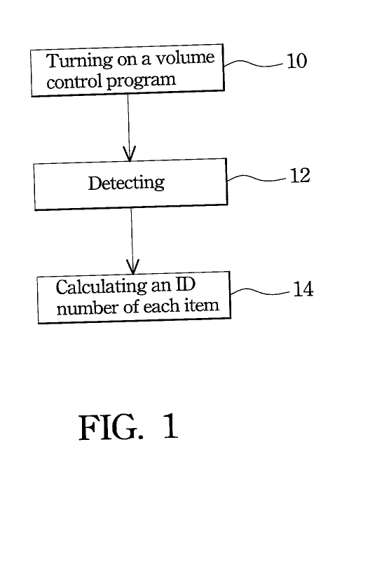

Referring to FIG. 1, this is a flowchart of automatic obtaining the ID number of items of a volume control program according to the present invention. The method of the invention comprises three main steps: turning on a volume control program 10, detecting items 12 and calculating an ID number of each item 14.

The first step 10 is turning on a volume control program, which is turning on the volume control program from a “Start” catalog of Microsoft Windows or other paths.

The secondary step 12 is detecting items, which is searching a desired item whether exists. If the item exists, an ID number of the item can be obtained.

The third step 14 is calculating the ID number of the item, which is calculating the ID number of each item such as volume, left-right sound track and muteness by using the obtained ID number of the item.

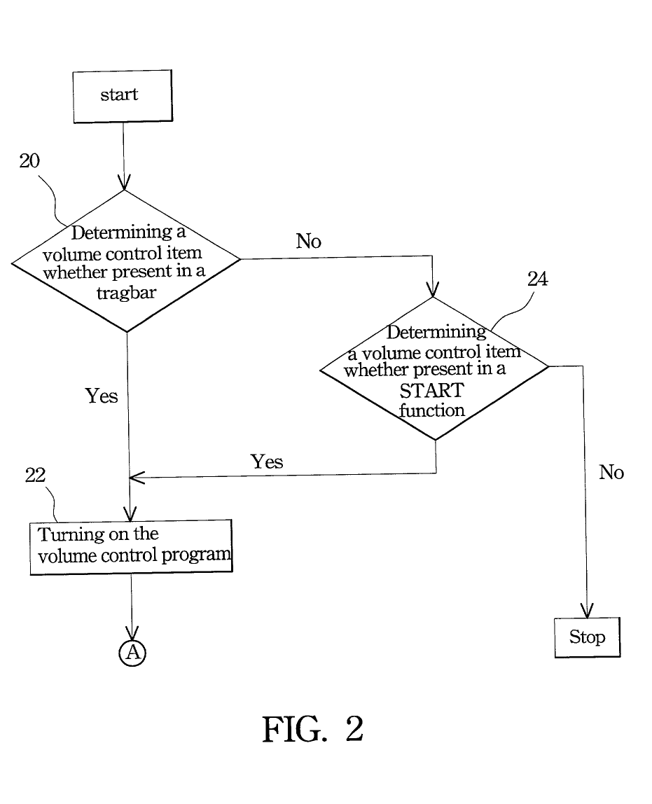

The detail process of the step 10 is described as shown in FIG. 2.

FIG. 2 shows a flowchart of a method for turning on a volume control program according to the present invention. Referring to FIG. 2, at first as shown in step 20, to automatic determine an item corresponded to a volume control program or a denotation corresponded to the volume control program whether present in a desktop of Windows or a tragbar. If the item or the denotation is present in the desktop of Windows or the tragbar, then turning on the volume control program 22 via the searched item or denotation to display a volume control program plane, and then stop the process.

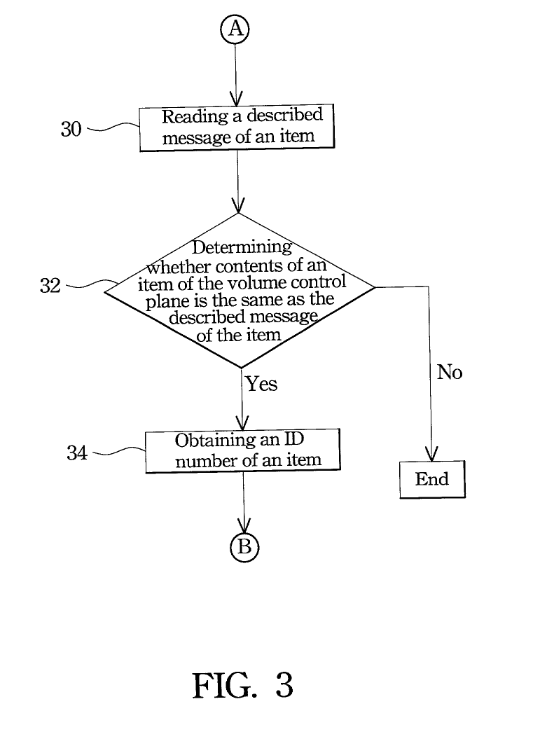

Inversely, if the item or the denotation is not present in the desktop of Windows or the tragbar in step 20, then proceeded to step 24. In step 24, to search a related path corresponded to the volume control program whether present in a START function program of Windows. If the related path corresponded to the volume control program is existed, then proceeded to step 22. In step 22, to turn on the volume control program and proceeded to the next step (that is, the step 12 of detecting items of FIG. 1 that detailed steps as shown in FIG. 3). Inversely, if the related path corresponded to the volume control program has not been found in step 24, which represents a function for controlling volume is not provided for the computer software. The process therefore can be stopped immediately.

The step 12 of detecting items of FIG. 1 that detailed steps as shown in FIG. 3 and will be described in detail hereafter.

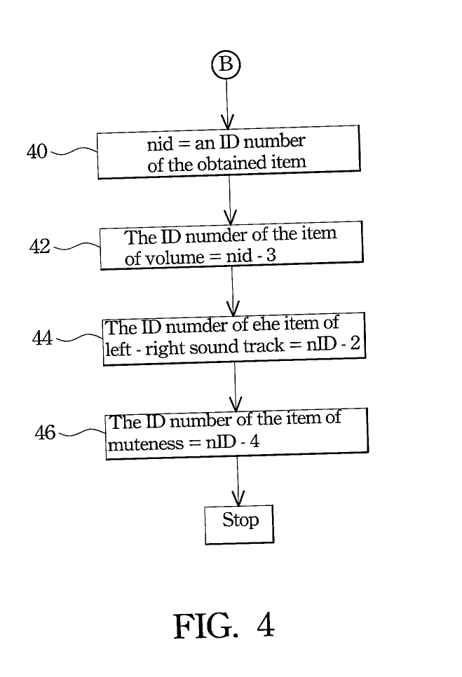

FIG. 3 shows a flowchart of detecting items according to the present invention. First, proceeded to step 30 to read a described message of an item such as a headword. Then, proceeded to step 32 to determine whether contents of an item of the volume control plane is the same as the described message of the item. If the contents are the same as the described message of the item, then an ID number of the item can be obtained, as described in step 34. Then, proceeded to step 14 of FIG. 1, which is the process as shown in FIG. 4 to calculate the ID number of the item.

Inversely, if the contents of step 32 are not the same as the described message of the item that represents the item is inexistent and then to stop the process.

The process for calculating the ID number of the item in step 14 of FIG. 1 as shown in FIG. 4 and will be explained in detail hereafter.

FIG. 4 shows a flowchart of calculating the ID number of items according to the present invention. The method for calculating an ID number of an item as shown in FIG. 4. First, proceeded to step 40 to set nID as the ID number of the obtained item. Then, proceeded to steps 42, 44 and 46 in turn and respectively to set the ID number of the item of volume as nID-3, the ID number of the item of left-right sound track as nID-2 and the ID number of the item of muteness as nID-4. Thus, these ID numbers of items of volume can be calculated via the ID number of the obtained item left-right sound track and muteness.

According to the above description, a method for automatic obtaining the ID number of items of a volume control program of the invention can effectively solve the above defects, occurred in the conventional technology.

A method for automatic obtaining the ID number of items of a volume control program of the invention can avoid the complication and inaccuracy occurred by a manual operation.

A method for automatic obtaining the ID number of items of a volume control program of the invention can standardize the detection process.

A method for automatic obtaining the ID number of items of a volume control program of the invention can enhance the accuracy and performance of the detection step of the adjustment process.

A method for automatic obtaining the ID number of items of a volume control program of the invention has a tidy compatibility and can broadly apply to various computers and hardware without limiting at a type of the computer and a design of hardware.

While the preferred embodiment of the invention has been illustrated and described, it will be appreciated that therein various changes can be made therein without departing from the spirit and scope of the invention.

What is claimed is:

1. A method for automatic obtaining the ID number of items of a volume control program, comprising the steps of:
turning on a volume control program;
detecting an item; and
calculating an ID number of another item.

2. The method for automatic obtaining the ID number of items of a volume control program according to claim 1, wherein the step of turning on the volume control program further comprises a step of determining a denotation corresponded to the volume control program whether present in a tragbar.

3. The method for automatic obtaining the ID number of items of a volume control program according to claim 2, wherein if the denotation is present in the tragbar, then turning on the volume control program to display a volume control plane.

4. The method for automatic obtaining the ID number of items of a volume control program according to claim 2, wherein if the denotation is not present in the tragbar, then searching a related path corresponded to the volume control program whether present in a START function program.

5. The method for automatic obtaining the ID number of items of a volume control program according to claim 4, wherein if the related path corresponded to the volume control program is present in the START function program, then turning on the volume control program to display a volume control plane.

6. The method for automatic obtaining the ID number of items of a volume control program according to claim 4, wherein if the related path corresponded to the volume control program is not present in the tragbar, then stopping the process.

7. The method for automatic obtaining the ID number of items of a volume control program according to claim 4, wherein if the related path corresponded to the volume control program is not present in the START function program, then stopping the process.

8. The method for automatic obtaining the ID number of items of a volume control program according to claim 1, wherein the step of detecting the item further comprises the steps of:
reading a described message of the item; and
determining whether contents of the item of the volume control plane is the same as the described message of the item.

9. The method for automatic obtaining the ID number of items of a volume control program according to claim 8, wherein if the contents are the same as the described message of the item, then an ID number of the item can be obtained and to calculate the ID number of the another item.

10. The method for automatic obtaining the ID number of items of a volume control program according to claim 8, wherein if the contents are not the same as the described message of the item, then stopping the process.

11. The method for automatic obtaining the ID number of items of a volume control program according to claim 9, wherein the step of calculating the ID number of the another item further comprises a step of setting the ID number of the item as nID.

12. The method for automatic obtaining the ID number of items of a volume control program according to claim 11, wherein the step of calculating the ID number of the another item further comprises a step of setting an ID number of the item of volume as nID-3.

13. The method for automatic obtaining the ID number of items of a volume control program according to claim 12, wherein the step of calculating the ID number of the another item further comprises a step of setting an ID number of the item of left-right sound track as nID-2.

14. The method for automatic obtaining the ID number of items of a volume control program according to claim 13, wherein the step of calculating the ID number of the another item further comprises a step of setting an ID number of the item of muteness as nID-4.

15. A method for automatic obtaining the ID number of items of a volume control program, comprising the steps of:
turning on a volume control program to display a volume control plane;
reading a described message of an item;
determining whether the described message of the item is the same as the item of the volume control plane;
if the described message of the item is the same as the item of the volume control plane, then an ID number of the item can be obtained; and
calculating an ID number of another item by using the obtained ID number of the item.

16. The method for automatic obtaining the ID number of items of a volume control program according to claim 15, wherein the item is an item of MIDI.

17. The method for automatic obtaining the ID number of items of a volume control program according to claim 16, wherein the another item is an item of volume.

18. The method for automatic obtaining the ID number of items of a volume control program according to claim 16, wherein the another item is an item of left-right sound track.

19. The method for automatic obtaining the ID number of items of a volume control program according to claim 16, wherein the another item is an item of muteness.
